(19) United States
(12) Patent Application Publication
(10) Pub. No.: US 2008/0103727 A1
(43) Pub. Date: May 1, 2008

(54) MULTICHANNEL ANALYZER

(75) Inventors: Koji Ota, Musashino-shi (JP); Hiroshi Yagyu, Musashino-shi (JP); Takashi Asakawa, Musashino-shi (JP); Ken-ichi Hironaga, Musashino-shi (JP); Hideyuki Fujii, Musashino-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: YOKOGAWA ELECTRIC CORPORATION, Tokyo (JP)

(21) Appl. No.: 11/926,739

(22) Filed: Oct. 29, 2007

(30) Foreign Application Priority Data
Oct. 30, 2006 (JP) 2006-293910

(51) Int. Cl. G06F 17/18

(52) U.S. Cl. 702/180

(57) ABSTRACT

There is provided an invention to implement a multichannel analyzer capable of executing high-precision measurement in short measurement time. The invention is an improvement of a multichannel analyzer for receiving pulse signals having respective peak values corresponding to radiation energy, and generating a histogram by selecting the respective peak values of the pulse signals on the basis of a lower limit value, and an upper limit value. The multichannel analyzer is characterized in comprising a conversion means for converting a voltage level of the pulse signal into a digital data block expressed in the same unit as that for the peak value at a predetermined sampling rate, a peak detector for detecting the peak value out of the digital data blocks of the conversion means, and a histogram analyzer for finding the number of occurrence times for each of the peak values, as selected after detection by the peak detector.

### FIELD OF THE INVENTION

The present invention relates to a multichannel analyzer for receiving pulse signals having respective peak values corresponding to radiation energy, and generating a histogram by selecting the respective peak values of the pulse signals on the basis of a lower limit value, and an upper limit value, and more particularly, to a multichannel analyzer capable of carrying out high-precision measurement in short measurement time.

### BACKGROUND OF THE INVENTION

A multichannel analyzer {hereinafter abbreviated as an MCA (Multichannel Analyzer)} is a measuring instrument for use in a radiation research field, counting the number of respective occurrence times of radiation rays outputted from a specimen to thereby generate a histogram (an energy spectrum) for identification of the kind of a radiation source, and so forth, and for analysis of time-dependent variation in intensity of the radiation source, a half life thereof, and so forth.

FIG. 4 is a block diagram showing a configuration of a conventional radiation-measuring instrument for measuring radiation energy from a specimen as a target for measurement to thereby identify the kind of a radiation source, and so forth (refer to, for example, Patent Documents 1 to 3). In FIG. 4, radiation rays outputted from a specimen 10 are inputted to a detector 11. Then, the detector 11 detects an electric charge corresponding to the radiation energy, that is, electric charges intrinsic to respective radiation sources, thereby outputting the electric charges as detected. Further, a front-end amplifier (for example, a charge amp.) 12 converts the electric charge from the detector 11 into a voltage value proportional to the electric charge. Still further, a waveform shaping amplifier 13 converts a signal from the front-end amplifier 12 into a pulse signal narrow in width {generally, in Gaussian line shape with a signal width FWHM (full width half maximum)=up to 1 [μs]}. Accordingly, a peak value (pulse height value) of the pulse signal from the waveform shaping amplifier 13 is proportional to the electric charge from the detector 11.

An MCA 14 carries out a measurement on the pulse signal inputted from the waveform shaping amplifier 13, thereby identifying the kind, and so forth of a radiation source (nuclear species) of the specimen. More specifically, because the peak value (voltage value) of the pulse signal contains information such as radiation energy from the specimen, and so forth, it is possible for the MCA 14 to determine from which kind of radiation source an output is made by finding the peak value. Furthermore, the MCA 14 counts the number of occurrence times for the respective peak values to thereby generate a histogram (an energy spectrum) wherein channel number is represented along the horizontal axis, and the number of the occurrence times (frequency) is represented along the vertical axis. In this case, the channel number refers to numbers corresponding to the respective peak values one-on-one.

In actual measurements, the specimen 10 contains a plurality of kinds of radiation sources, and therefore, more often than not, a measurement is carried out by aiming at only desired kinds of radiation sources. Further, because energy from the specimen 10 is weak, noise occurs to the detector 11, the amplifiers 12, 13, and so forth. In consequence, peak values of the noises as well are detected, so that the energy spectrum includes the noises.

Accordingly, in order to select a spectral portion of interest only, or to remove noise regions, there is set an ROI (Region of Interest) corresponding to a desired spectral width {that is, a channel width between an n-th channel and an m-th channel (provided that n, m each are a natural number, and n<m, a lower limit value of the n-th channel being referred to as LLD (Lower Level Discrimination) while an upper limit value of the m-th channel being referred to as ULD (Upper Level Discrimination)) in the MCA 14, and the MCA 14 generates an energy spectrum in the ROI as set.

After a measurement in all the channels (a spectrum region in whole, measurable by the MCA 14) is once carried out to thereby generate an energy spectrum, the ROI is normally set while watching the spectrum. Subsequently, a re-measurement is carried out within the ROI as set.

However, the number of noise counts is overwhelmingly greater than the number of the occurrence times for each of the pulse signals generated from the radiation sources of the specimen 10, so that the spectrum of the radiation source becomes relatively very small. For this reason, there is the need for resetting the ROI a plurality of times to thereby remove only noises.

Further, because there is the necessity for causing a voltage level of an input signal to the MCA 14 to fall within a predetermined range as determined by the MCA 14 (because of the risk of inputting of an excessive voltage causing breakdown of the MCA 14), it is necessary to optimize the voltage level of the input signal. That is, this is so because there is a case where the energy of a radiation source to be truly aimed at is too large, and is not included in the spectrum being observed at the MCA 14, and conversely, there is a case where measurement is carried out by excessively lowering an amplification factor for the input signal, due to overestimation on the magnitude of the energy.

Accordingly, as shown in FIG. 4, the signal inputted from the waveform shaping amplifier 13 to the MCA 14 is bifurcated, thereby inputting one portion thereof to the MCA 14, and the other to an oscilloscope 15. Then, waveforms of the pulse signals, displayed on a screen of the oscilloscope 15, are observed, noise levels are checked, and observation is made on the respective peak values, and so forth, of the radiation sources, thereby adjusting respective gains of the amplifiers 12, 13 before inputting the pulse signal at an optimum voltage level to the MCA 14, and setting the ROI with reliability.
[Patent Document 1] JP-02-47542-A
[Patent Document 2] JP-2002-181947-A
[Patent Document 3] JP-2002-055171-A

Thus, by observing the waveform itself of the pulse signal inputted to the MCA 14, on the oscilloscope 15, noise levels can be checked, and the voltage level of the input signal can be optimized.

However, the waveforms of the pulse signals, displayed on the oscilloscope 15, are expressed in a graph formed by plotting time along the horizontal axis and the voltage levels along the vertical axis, while the energy spectrum of the MCA 14 is expressed in a graph formed by plotting the peak value along the horizontal axis, and the number of occurrence times along the vertical axis. Accordingly, in order to set the ROI in the MCA 14, it has been required that the voltage level on the oscilloscope 15 be converted so as to change the voltage to the channel number by taking into account conversion efficiency of the detector 11, respective amplification factors of the amplifiers 12, 13, corresponding relationship within the MCA 14 (relationship of the peak values with the respective channel numbers corresponding thereto), and so forth. For this reason, it has take time to set the ROI, thereby causing a problem in that it has taken longer time before the completion of a measurement in the ROI as desired.

Furthermore, it has been necessary to bifurcate an electrical signal line between the amplifier 13 and the MCA 14, thereby connecting the oscilloscope 15 to the signal line. As a result, the oscilloscope 15 provided on the signal line between the amplifier 13 and the MCA 14, and a signal line leading to the oscilloscope 15 will each act as a noise source, thereby causing a problem of degradation in quality of signals delivered to the MCA 14. For this reason, in the case of carrying out a measurement with high precision, there has been the need for executing re-measurement after removal of the oscilloscope 15, causing a problem of longer time required for the measurement. If the signal is not bifurcated, it has been necessary to change over connection of the MCA 14 with the oscilloscope 15 every tine the waveform is observed, thereby causing a problem of longer time required for the measurement.

### SUMMARY OF THE INVENTION

It is therefore an object of the invention to implement a multichannel analyzer capable of executing high-precision measurement in short measurement time.

In accordance with a first aspect of the invention, there is provided a multichannel analyzer for receiving pulse signals having respective peak values corresponding to radiation energy, and generating a histogram by selecting the respective peak values of the pulse signals on the basis of a lower limit value, and an upper limit value, said multichannel analyzer comprising a conversion means for converting a voltage level of the pulse signal into a digital data block expressed in the same unit as that for the peak value at a predetermined sampling rate, a peak detector for detecting the peak value out of the digital data blocks of the conversion means, and a histogram analyzer for finding the number of occurrence times for each of the peak values, as selected after detection by the peak detector.

Said multichannel analyzer preferably comprises a display processor for concurrently displaying respective waveforms of the pulse signals on the basis of the digital data blocks by the conversion means, with time expressed along the horizontal axis, and the peak value expressed along the vertical axis, and the energy spectrum with the peak value expressed along the horizontal axis and the number of the occurrence times, expressed along the vertical axis on the basis of the number of the occurrence times, found by the histogram analyzer, on the same screen.

The display processor preferably displays a cursor indicating the lower limit value, or the upper limit value in the waveform, and in the energy spectrum, respectively.

Said multichannel analyzer with those features may further comprise a computation means for finding the upper limit value on the basis of the respective waveforms of the pulse signals.

Further, the peak detector may execute a peak detection among a predetermined number of the digital data blocks, counted from the digital data block exceeding the lower limit value, serving as a reference while a computation means for finding the predetermined number of the digital data blocks on the basis of the respective waveforms of the pulse signals may be provided.

The invention has the following advantageous effects.

Since a unit of the waveform display of the pulse signal, along the vertical axis, is rendered identical to a unit of the energy spectrum, along the horizontal axis, the lower limit value, and the upper limit value can be easily set on the basis of the waveform of the pulse signal. Further, without the use of another equipment such as an oscilloscope, and so forth, a voltage level of the pulse signal can be optimized. Accordingly, it is possible to execute high-precision measurement in short measurement time.

As the waveform of the pulse signal, and the energy spectrum are concurrently displayed on the same screen, rendering it easier to set the lower limit value, and the upper limit value, so that measurement time can be further shortened.

### BREIF DESCRIPTION OF THE DRAWINGS

FIG. 1 is a bock diagram showing one embodiment of an MCA according to the invention;

FIG. 2 is a view showing an example of a display screen of the MCA shown in FIG. 1;

FIG. 3 is a flow chart showing an example of an operation of the MCA shown in FIG. 1, and

FIG. 4 is a block diagram showing a configuration of a conventional radiation-measuring instrument.

### PREFERRED EMBODIMENTS OF THE INVENTION

An Embodiment of the invention is described hereinafter with reference to the accompanying drawings.

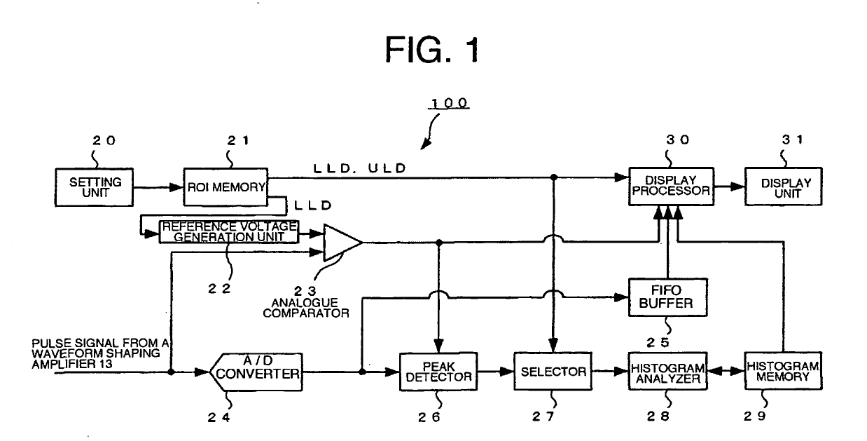

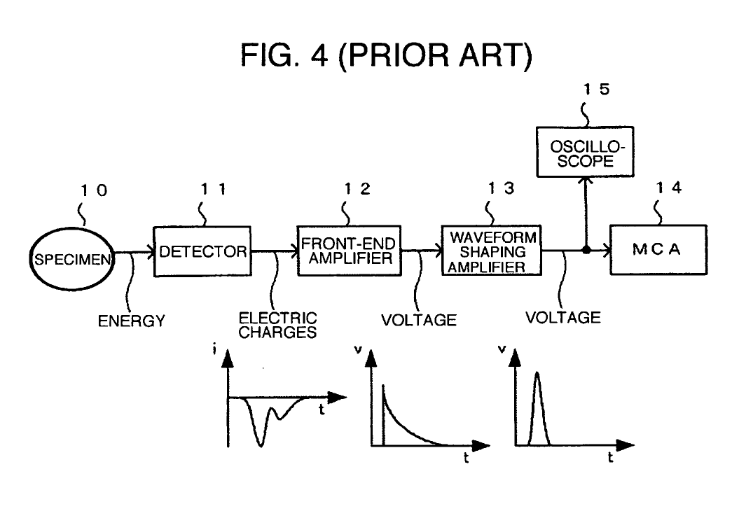

FIG. 1 is a bock diagram showing one embodiment of an MCA according to the invention. In the figure, parts corresponding to those in FIG. 4 are denoted by like reference numerals, omitting description thereof. An MCA 100 shown in FIG. 1 is provided in place of the MCA 14 in FIG. 4, and the oscilloscope 15 shown in FIG. 4 is unnecessary.

In FIG. 1, a setting unit 20 sets LLD and ULD. An ROI memory 21 stores the LLD and the ULD that are set in the setting unit 20.

A reference voltage generation unit 22 reads the LLD out of the ROI memory 21, thereby generating a voltage corresponding to the LLD.

A pulse signal from a waveform shaping amplifier 13 is inputted to an analogue comparator 23, and a signal at a level of the voltage corresponding to the LLD, from the reference voltage generation unit 22, is inputted to the analogue comparator 23, thereby comparing voltage levels of the pulse signals with a voltage level of the reference voltage generation unit 22.

An A/D converter 24 is a conversion means, to which the pulse signals from the waveform shaping amplifier 13 are inputted. The pulse signal from the waveform shaping amplifier 13 is bifurcated to be delivered into the analogue comparator 23, and the A/D converter 24 such that signals in sync with each other are inputted thereto, respectively.

An FIFO buffer 25 stores digital data blocks from the A/D converter 24. The digital data blocks from the A/D converter 24 are inputted to a peak detector 26, which detects the respective peak values of the pulse signals on the basis of results of comparison by the analogue comparator 23.

The peak values detected by the peak detector 26 are inputted to a selector 27, which reads the LLD, the ULD out of the ROI memory 21, thereby selecting only the peak values falling between the LLD, and the ULD, that is, only the peak values in the ROI to be then outputted.

The peak values selected by the selector 27 are inputted to a histogram analyzer 28, which portions out the peak values among channels, each being partitioned so as to fall within a predetermined range, whereupon the number of the occurrence times for each of the peak values is counted to be subsequently read from, and written to a histogram memory 29. In the histogram memory 29, the channels have respective regions allocated thereto, storing the number of the occurrence times on a channel-by-channel basis.

Comparison results sent out from the analogue comparator 23 are inputted to a display processor 30, which reads the LLD, the ULD out of the ROI memory 21, the digital data blocks out of the FIFO buffer 25, and the number of the occurrence times for each of the peak values out of the histogram memory 29, thereby displaying waveforms as time-dependent waveforms of the pulse signals, the energy spectrum, the LLD, the ULD, and so forth on a display unit 31.

Further, it is assumed for the sake of clarity in description that the respective voltage levels of the pulse signals inputted to the MCA 100 are to fall in a range of 0 to 10 [V], and the A/D converter 24 has resolution of 14 [bit] (=0 to 16383). For example, if 0 [V] is inputted, the A/D converter 24 outputs the digital data block at a value of “0”, and if 10 [V] is inputted, the A/D converter 24 outputs the digital data block at a value of “16383”.

Further, it is assumed that the digital values of the A/D converter 24 correspond to channel numbers one-on-one. More specifically, if the digital value (the peak value of the pulse signal) of the A/D converter 24 is “1000”, the peak value in the energy spectrum also becomes “1000”, so that a unit of the digital value according to the A/D converter 24 is converted into the same unit (channel number) as that for the energy spectrum.

Operation of such an instrument as described is described hereinafter.

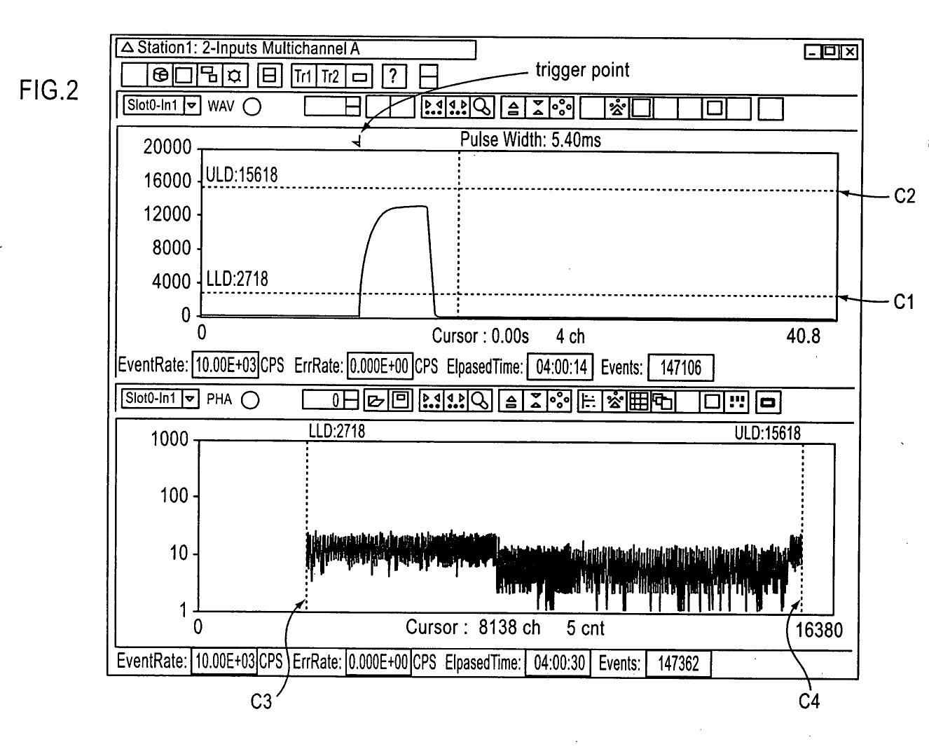

FIG. 2 is a view showing an example of a display screen of the display unit 31. The display screen shown in FIG. 2 is divided into two parts, an upper tier part, and a lower tier part, showing an example wherein the waveform of the pulse signal is displayed in the upper tier part, and the energy spectrum is displayed in the lower tier part. Further, with waveform display in the upper tier part, the horizontal axis represents time, and the vertical axis represents the peak value. With the energy spectrum in the lower tier part, the horizontal axis represents the peak value (that is, the channel number), and the vertical axis represents the number of the occurrence times.

The LLD, and the ULD are set in the setting unit 20, and those set values LLD and ULD are stored in the ROI memory 21. In FIG. 2, the LLD=“2718”, and ULD=“15616” are set by way of example.

Then, the analogue comparator 23 compares the pulse signals from the waveform shaping amplifier 13 with the voltage level of the reference voltage generation unit 22, outputting a signal at L-level if the voltage level of the pulse signal is lower than the LLD while outputting a signal at H-level if the voltage level of the pulse signal is higher than the LLD.

Meanwhile, the A/D converter 24 converts the pulse signals into the digital values at a predetermined sampling rate to be stored in the FIFO buffer 25 while outputting the digital values to the peak detector 26.

Further, the display processor 30 reads the digital data blocks out of the FIFO buffer 25, but it is at a point in time when the voltage level of the pulse signal exceeds the LLD that the display processor 30 starts reading the digital data blocks, that is, a point in time when an output of the analogue comparator 23 undergoes a change from L-level to H-level is taken as a trigger point. Subsequently, the display processor 30 reads a predetermined number of the digital data blocks before and after the digital data block exceeding the trigger point to be then displayed in the display unit 31. In this case, the horizontal axis is a time axis, but the vertical axis displays the peak value (the digital value=the channel number, converted by the A/D converter 24 as described above) instead of voltage. Further, the display processor 30 may indicate the trigger point in the figure as shown in FIG. 2.

Meanwhile, the peak detector 26 detects the respective peak values of the pulse signals on the basis of the digital data blocks inputted from the A/D converter 24. For example, assuming the LLD to be a threshold, the peak detector 26 detects a maximum value in the predetermined number of the digital data blocks from the digital data block exceeding the threshold. More specifically, the point in time when the output of the analogue comparator 23 undergoes the change from L-level to H-level is taken as the trigger point. Then, the digital data block after the trigger point being taken as a reference, there is detected the digital data block at the maximum value among the digital data blocks included in a range of the predetermined number of the digital data blocks from the digital data block serving as the reference. In this connection, the predetermined number of the digital data blocks, for use in detection of the peak value, is preset in the peak detector 26 beforehand through the intermediary of the setting unit 20. Such setting is preferably made on the basis of, for example, the sampling rate of the A/D converter 24, and respective pulse widths of the pulse signals. Then, the digital data blocks as detected are outputted as the peak values to the selector 27.

Further, the selector 27 compares the peak values with the LLD, and the ULD, respectively, whereupon only the peak values that fall within the ROI between the LLD and the ULD are outputted to the histogram analyzer 28.

Subsequently, the histogram analyzer 28 determines the channels to which the respective peak values are portioned out on the basis of the peak values selected by the selector 27. Further, the histogram analyzer 28 reads a count value out of respective regions of the histogram memory 29, corresponding to channel numbers determined by the histogram analyzer 28 (needless to say, an initial value of the count value in each of the regions is “0”). Subsequently, the count value as read by the histogram analyzer 28 is incremented by “+1”, and the count value as incremented is written to the region from which the count value is read. Such an operation of the histogram memory 29 to increment the count value is carried out for predetermined time Δt. Accordingly, a histogram showing the number of the occurrence times of the pulse signal per each of the channels {the horizontal axis indicating the channel (that is, peak value), and the vertical axis indicating the number of the occurrence times) is stored in the histogram memory 29.

After execution of a measurement for the predetermined time Δt, the display processor 30 reads the count values of the respective channels, thereby displaying the energy spectrum. Upon completion of the measurement for the predetermined time Δt, the count value in each of the regions of the histogram memory 29 is cleared, and the next measurement is executed. Since the peak values according to the ROI are selected by the selector 27, there is displayed the number of the occurrence times for each of the peak values only within the ROI.

Further, the energy spectrum may be displayed by reading the numbers of the occurrence times for the respective peak values together out of the histogram memory 29 after the execution of the measurement for the predetermined time Δt, or the number of the occurrence times for the peak value may be read out of the histogram memory 29 every time when the number of the occurrence times for the respective peak values undergoes a change, thereby re-rendering the energy spectrum at every change in the number of the occurrence times before displaying the same.

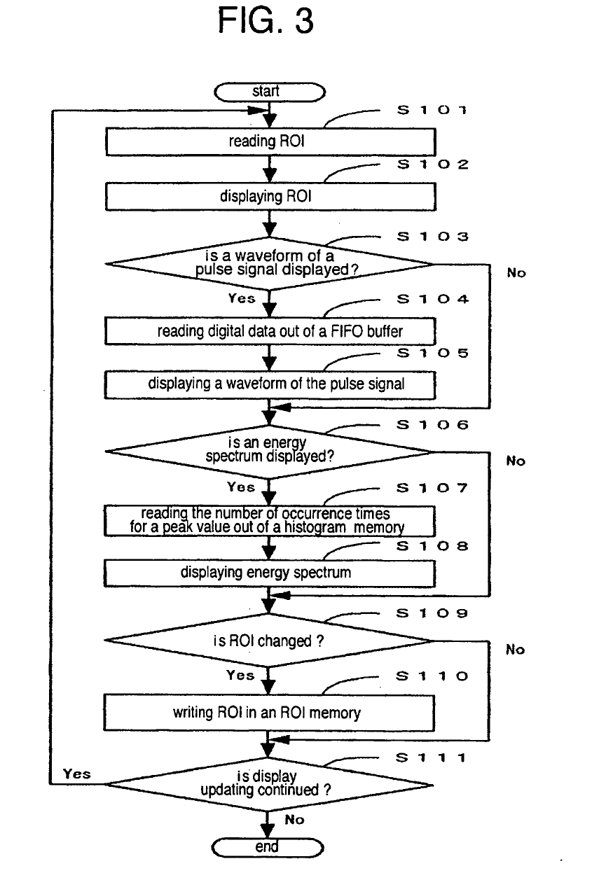

Now, there is described an operation of the display processor 30 to display the waveform of the pulse signal, the energy spectrum, and the ROI (LLD, ULD) with reference to a data flow chart of FIG. 3. FIG. 3 is a flow chart showing an example of an operation of the MCA 100.

The display processor 30 reads the ROI from the ROI memory 21 (step S101), displaying the LLD, ULD by means of a cursor in a waveform display of the pulse signal, shown in the upper tier part of the display screen, and in an energy spectrum display shown in the lower tier part of the display screen, respectively. Needless to say, in the waveform display of the pulse signal, the cursor C1 indicating the LLD, and the cursor C2 indicating the ULD are in parallel with the horizontal axis, respectively. Further, in the energy spectrum display, the cursor C3 indicating the LLD, and the cursor C4 indicating the ULD are in parallel with the vertical axis, respectively. And, respective values of the LLD, ULD are displayed in the vicinity of the respective cursors C1 to C4 (step S102).

When executing the waveform display of the pulse signal, the display processor 30 reads digital data out of the FIFO buffer 25 (steps S103, S104), thereby executing the waveform display of the pulse signal (step S105).

After execution of the waveform display (S105), or if the waveform display is not executed (S103), the operation proceeds to step (S106) for determination on whether or not the energy spectrum is displayed. If the energy spectrum is displayed, the display processor 30 reads (steps S106, S107) the number of the occurrence times for the peak value out of the histogram memory 29, thereby executing the energy spectrum display (step S108).

After execution of the energy spectrum display (S108), or if the energy spectrum display is not executed (S106), the operation proceeds to step (S109) for determination on whether or not the ROI is changed. If the ROI is changed, that is, if new LLD, ULD are set by the setting unit 20, the setting unit 20 changes the LLD, ULD that are stored in the ROI memory 21 (steps S109, S110).

After completion of a change in the ROI memory 21 (S110), or if the ROI is not changed (S109), the operation proceeds to step (S111) for determination on whether or not display updating is continued. If display updating is to be continued, the display processor 30 reads the ROI, thereby repeating the respective steps (S111, S101 to S110). If display updating is not executed (S181), the operation is completed.

Thus, since a unit of the waveform display of the pulse signal, along the vertical axis, is identical to a unit of the energy spectrum, along the horizontal axis, it is unnecessary to effect conversion from the voltage to the channel number by taking into account the conversion efficiency of the detector 11, the respective amplification factors of the amplifiers 12, 13, the corresponding relationship within the MCA 14, and so forth, as is the case for the instrument shown in FIG. 4. Accordingly, it does not take time to set the ROI. Furthermore, the voltage level of the pulse signal can be optimized without use of the oscilloscope 15. In consequence, it is possible to execute a high-precision measurement in short measurement time.

Further, since the waveform of the pulse signal, and the energy spectrum are concurrently displayed on the same screen while LLD, ULD, delineating a range of the ROI, are shown in both the waveform display of the pulse signal, and the energy spectrum display, the ROI can be set with greater ease, and the measurement time can be further shortened

It is to be pointed out that the invention is not limited to the embodiment described in the foregoing, and may include the following:
(1) With the instrument shown in FIG. 1, there has been shown a configuration where use is made of the ROI memory 21, the FIFO buffer 25, and the histogram memory 29, however, any memory capable of storing digital values may be used instead.
(2) There has been shown a configuration where the peak detector 26 assumes the LLD as the threshold, detecting the threshold upon the output of the analogue comparator 23 undergoing the change from L-level to H-level, however, a value other than the LLD may be assumed as the threshold, and a separate comparator for detection of the threshold may be provided.
(3) The MCA 100 in whole may be housed in one enclosure, or the MCA 100 may be made up in the form of modules to be used in combination with a PC, and so forth. For example, in the case of the MCA 100 in whole being housed within one enclosure, a front panel of the MCA 100 may be provided with operational buttons and rotary knobs, serving as a setting unit, and a display screen serving as a display unit. Further, parts of the MCA 100 may be made up in the form of a module to be plugged into a slot of a PC. For example, a keyboard and a mouse of the PC may be substituted for the setting unit 20, a CPU of the PC for display processor 30, and a screen of the PC for the display unit 31 while other components including the ROI memory 21 to the histogram memory 29 may be mounted in the module. Further, a module unit may be plugged into another station (for example, an instrument where various types of modules can be mounted), thereby carrying out communication between the station and the PC so as to serve as the MCA 100.
(4) There has been shown a configuration wherein the peak detector 26 executes a peak detection among the predetermined number of the digital data blocks counted from the digital data block exceeding the LLD, however, a computation means for finding the predetermined number may be provided. For example, the computation means may find FWHM from the digital data blocks in the FIFO buffer 25 on the basis of the peak value detected by the peak detector 26 to thereby compute the predetermined number. Or the number of the digital data blocks from one exceeding the LLD up to one falling short of the LLD may be counted on the basis of the digital data blocks in the FIFO buffer 25, thereby computing the predetermined number. Such computation being carried out with respect to a plurality of the pulse signals, the computation means outputs the predetermined numbers as computed to the peak detector 26. By so doing, it is possible to render an optimum measurement interval (time) at the time of a peak detection to be an adequate number (a value neither excessive nor insufficient), so that the peak detection can be efficiently executed, thereby shortening the measurement time.
(5) There has been shown a configuration wherein the setting unit 20 causes the ULD to be set in the ROI memory 21, however, a computation means for finding the ULD may be provided. For example, the computation means may read the digital data blocks out of the FIFO buffer 25 to find a maximum value in the predetermined time Δt, whereupon the maximum value or a value slightly greater than the maximum value (with addition of a value in a range of several to several tens) is assumed to be the ULD to be subsequently stored in the ROI memory 21. By so doing, it becomes unnecessary for a user to set the ULD, thereby further shortening the measurement time.
(6) There has been shown a configuration wherein if the digital value (the peak value of the pulse signal) of the A/D converter 24 is “1000”, the peak value in the energy spectrum also becomes “1000”, however, the corresponding relationship is not limited thereto. For example, a means for further effecting conversion of the digital value may be provided among the A/D converter 24, the FIFO buffer 25, and the peak detector 26, and the upshot is that a unit of an amplitude value of the digital value, used in the waveform display of the pulse signal, need be the same as a unit of the peak value (channel number), on which the histogram analyzer 28 finds the number of the occurrence times.
(7) There has been shown a configuration wherein the peak detector 26 acquires the digital data blocks directly from the A/D converter 24, however, the peak detector 26 may sequentially read the respective predetermined numbers of the digital data blocks stored in the FIFO buffer 25, thereby detecting the respective peak values of the pulse signals.

What is claimed is:

1. A multichannel analyzer for receiving pulse signals having respective peak values corresponding to radiation energy, and generating a histogram by selecting the respective peak values of the pulse signals on the basis of a lower limit value, and an upper limit value, said multichannel analyzer comprising:
a conversion means for converting a voltage level of the pulse signal into a digital data block expressed in the same unit as that for the peak value at a predetermined sampling rate;
a peak detector for detecting the peak value out of the digital data blocks of the conversion means; and
a histogram analyzer for finding the number of occurrence times for each of the peak values, as selected after detection by the peak detector.

2. The multichannel analyzer according to claim 1 further comprising a display processor for concurrently displaying respective waveforms of the pulse signals on the basis of the digital data blocks by the conversion means, with time expressed along the horizontal axis, and the peak value expressed along the vertical axis, and the energy spectrum with the peak value expressed along the horizontal axis and the number of the occurrence times, expressed along the vertical axis on the basis of the number of the occurrence times, found by the histogram analyzer, on the same screen.

3. The multichannel analyzer according to claim 2, wherein the display processor displays a cursor indicating the lower limit value, or the upper limit value in the waveform, and in the energy spectrum, respectively.

4. The multichannel analyzer according to any of claims 1 to 3 further comprising a computation means for finding the upper limit value on the basis of the respective waveforms of the pulse signals.

5. The multichannel analyzer according to any of claims 1 to 3, wherein the peak detector executes a peak detection among a predetermined number of the digital data blocks, counted from the digital data block exceeding the lower limit value, serving as a reference, and further comprising a computation means for finding the predetermined number of the digital data blocks on the basis of the respective waveforms of the pulse signals.
